(19) United States
(12) Patent Application Publication
(10) Pub. No.: US 2020/0315145 A1
(43) Pub. Date: Oct. 8, 2020

(54) Method and Apparatus for Improved Handling and Attachment of Living Sessile Organisms to Substrate and Habitat Enhancement

(71) Applicant: Christopher Francis O'Hare, Boynton Beach, FL (US)

(72) Inventor: Christopher Francis O'Hare, Boynton Beach, FL (US)

(21) Appl. No.: 16/809,507

(22) Filed: Mar. 4, 2020

Related U.S. Application Data
(60) Provisional application No. 62/813,322, filed on Mar. 4, 2019.
(60) Provisional application No. 62/857,556, filed on Jun. 5, 2019.

(51) Int. Cl. A01K 61/20

(52) U.S. Cl. CPC A01K 61/20

(57) ABSTRACT

Examples of the disclosure provide for an apparatus for actively restoring and promoting marine life. Said apparatus includes a mounting component and a receiver component. Said mounting and receiving components are capable of mechanically joining with each other. Said mounting component provides a base for stable attachment of a living sessile organism. Said receiver component provides stable anchoring for said mounting component. Various embodiments of said apparatus function to facilitate propagation, protective transport and efficient out planting of said organisms in a submerged marine environment.

### FIELD OF THE ART

The disclosure relates to the field of propagation, cultivation and planting of living sessile organisms in a submerged marine environment, in particular to an apparatus and method for improved handling and processing of live sessile organisms and related enhancement of marine ecosystems.

### BACKGROUND OF THE INVENTION

Environmental concerns for diminishing marine life, loss of biologically active reefs, and other impacts have led to the installations of artificial reefs throughout much of the Earth's coastal ocean environments. Historically, artificial reefs are built using obsolete objects such as rubber tires, concrete and steel scrap, ships, tanks, planes, train cars and other objects originally made for another purpose and repurposed into an artificial reef. These deployed “objects of opportunity” have caused environmental concerns, such as the introduction of pollutants into the marine environment, the creation of less than attractive marine environments and, in the case of the tire reef deployment adjacent to Broward County Florida, acres of submerged dead zones which now are costing many thousands of dollars to mitigate.

In addition, these repurposed objects often provide a less than ideal environment for growth of reef inhabitants. For example, submerged metal objects have been observed to only temporarily support colonization of attaching organisms as the growing organism eventually gain enough mass to exceed the adhesive force that holds it in place. The organism can no longer be supported by the corroding metal substrate to which it is attached. This causes the organism to eventually detach and fall away only to be replaced by a fresh attaching organism that eventually experiences the same fate.

Another risk of deploying “objects of opportunity” is their inherent instability. Current regulatory guidelines require deployed artificial reef objects to remain stable during a 50-year storm event. An unstable and rolling object not only jeopardizes any living organisms attached to its surface but also threatens to crush any adjacent living organisms which may be in the path of the storm-tossed unstable object.

Also, recent advancements in concrete recycling technology have now made it economically feasible to grind waste concrete into aggregate suitable for reuse. This has led to a decrease in waste concrete objects that would otherwise be available for deployment as an artificial reef. Artificial reef coordinators from various South Florida Counties now recognize the inherent risk of deploying “objects of opportunity” and currently favor building artificial reefs by stacking large piles of natural stone boulders or deploying engineered concrete modules specifically designed to withstand a 50-year storm event.

Unfortunately, many of these new reef creations rely on nearby reefs to attract fish and other living organisms rather than creating new populations of marine life. The age-old argument remains as to whether the new reefs merely aggregate fish where they may be more easily harvested by fishermen or whether they serve to expand fish stocks.

One reason for the limited colonization by marine organisms of new artificial reefs may be due to the lack of biologically robust donor reefs located sufficiently proximate to the new reef and which, if closer, would otherwise allow for the survival of migrating larvae but which said larvae, instead perish before reaching the new reef substrate.

Another issue that may diminish the ability of the new reefs to increase fish populations is the lack of effective habitat needed to support the very small fish that are the basis for the reef's food chain. Recent studies have determined that over half the total amount of food consumed by reef dwellers are fish that are less than 20 centimeters in length. Minor recesses, holes and crevices are conducive to providing protection from predation for these fish and early development of juvenile fish. Voids and interior chambers of rock pile reefs and artificial reef modules typically have interconnected interstitial spaces which are typically home to larger predatory fish. Many small and juvenile fish seeking refuge in these spaces are instead consumed by those larger organisms before reaching sexual maturity. As well, a close examination of most natural reefs, especially flat, hardbottom reefs typically found in Florida reveals a profound lack of protective habitat for small and juvenile fish. Minor topographic projections and recesses in the natural rock, along with projections of organisms attached to that rock and occasional thickets of branching corals are typically the only physical protective resource available to small and juvenile fish. Providing habitat for small and juvenile fish that would allow them to reach reproductive maturity can exponentially increase fish populations and therefore a broader basis of support to organisms further up the food chain.

While the issue of creating habitat which is specifically designed to provide protection from predation for many small and juvenile fish has not been adequately addressed prior to this invention there have, however, recently been great advancements in techniques to culture living sessile organisms for the purpose of restoring natural coral reefs. Said advancements may be employed to create new coral reefs in locations where none currently exist.

Many sessile benthic marine organisms including hard and soft corals, sponges and similar organisms use asexual fragmentation to increase biomass and colony expansion. By this means, organisms readily fracture and reattach to new or adjacent substrate. Discovery of this biological reproduction characteristic has inspired the creation of a marine organism nursery culture industry. Ongoing re-fragmentation, propagation and replanting methods have been developed and used by aquarium hobbyists, marine scientists and others for breeding, enhancement and restoration of biological marine systems. Indeed, the science is well established and expanding in the field of coral propagation through fragmentation of rescued and maturing nursery grown corals. These techniques are especially useful for breeding “super” corals which are resistant to disease, hardier and more resilient for resisting the challenges of climate change. Many organizations, including private foundations, universities and NGOs have successfully developed methods for producing nursery grown corals in controlled environments. These organizations are growing corals faster and in greater number than the corals can be practically relocated to the offshore reef. Researchers have discovered that it is much easier to grow thousands of coral fragments in the nursery than it is to out plant them on an artificial or natural reef. Mass production of fragmented coral polyps is now common throughout the world, however current out planting methods are slow, time consuming, stressful for the coral organisms and many times result in out planted corals failing to survive.

Current methodologies in out planting of said cultured organisms rely on a myriad of techniques to attach said organism to submerged substrate including knots, nails, cable-ties, cements or adhesives, all of which require trained technicians and time under stable or calm sea conditions to accomplish. As well, rough handling of delicate organisms during the transportation and stabilization phase of the out-planting process causes undue stress on said organisms which sometimes results in excessive mortality rates.

The current method most popular for transplanting stony corals to a marine substrate is as follows:
The coral organism is grown on a portable substrate such as a small tile or “frag plug” which is a small disc shape with a bottom stem used to stabilize the plug in a grate panel during cultivation.
The coral and substrate are removed from the growing area and transported to the deployment site. In the case of the frag plug, the stem is removed by cutting or braking off.
The corals are jostled and bumped around in a bucket or tray while transported to the attachment site.
The area selected for attachment is first abraded and otherwise scarified of any bio film material that would inhibit adhesion. The debris from this process typically drifts onto adjacent substrate and organisms.
The coral and portable substrate are then fixed to the scraped substrate with a cement based or polymer based adhesive material and held in place until the material sufficiently cures.

Corals attached in this way may suffer stress from excessive handling, are at risk of detachment from the substrate, exposed to possible damage from silting and subject to predation from certain fish species. In addition, this method is labor intensive, difficult to complete successfully and inadequate for the number of corals needed and available for out planting.

An efficient and sustainable method and apparatus for stabilizing said living sessile organisms during cultivation and transportation in addition to quickly attaching an abundance of said organisms to submerged structure is needed. Said organisms must be transported to the deployment location in a stable manner that prevents jostling, bumping and trauma to said organism. As well said organism must be fixed to the submerged substrate in an efficient and scalable manner that allows the installing technician to be most productive. The present invention provides an easier, more successfully productive, less labor intensive, less stressful and more environmentally responsive alternative method to current industry practices for the attachment of living corals and other sessile organisms to submerged structure. Some embodiments of said invention also create much needed protective habitat for small and juvenile fish.

The instant invention provides an apparatus and method for the rapid, efficient and less stressful attachment of living corals to submerged substrate in addition to providing protective habitat for small and juvenile fish.

### SUMMARY OF THE INVENTION

Accordingly, the instant invention provides an apparatus and method of stabilizing living sessile organisms during the propagation and out planting phase of living reef creation and restoration resulting in rapid, efficient and less stressful attachment of living sessile organisms to submerged substrate in addition to creating and providing protective habitat for small and juvenile fish. The instant invention is a method and apparatus for attaching living sessile marine organisms to artificial reef structures and other submerged structures. Said invention provides for the efficient, sustainable and environmentally responsive attachment of living sessile marine organisms that are either relocated from their natural environment or are grown under nursery conditions. As well, some embodiments of said apparatus provide protective habitat for small and juvenile fish. In general, said apparatus described herein are comprised of two separate components, a mounting component and a receiver component. Said mounting component is capable of securely supporting a living sessile organism which is attached to said mounting component by either chemical adhesion or mechanical means. Said mounting component, by virtue of said component's shape is capable of being mechanically joined to said receiver component which, by virtue of said receiver components shape is capable of being mechanically joined to said mounting component. Said receiver component is attached to natural substrate or is attached to a fabricated object such as an artificial reef or artificial reef component. Another embodiment of said receiver component is incorporated into a fabricated object such as an artificial reef or artificial reef component. Another embodiment of said receiver component may also support a plurality of said mounting components during culture of said organisms in a nursery environment, during transport of said organisms or as substrate intended to be submerged in an underwater environment.

Another embodiment of said mounting component provides surface area suitable to support foreign substrate objects such as plugs, tiles or other rigid objects which have been previously affixed with fragments of divided living sessile organisms. Said objects, with attached said organism fragments may be attached to said mounting component with chemical adhesive material. In this way, cultured sessile organisms previously mounted to said objects may be attached to, and benefit by, the unique characteristics of said invention.

Said receiver component, whether attached to, or incorporated into, said fabricated objects serves to provide support for said mounting component and said attached living organism.

Said apparatus composed of said mounting component and said receiver component incorporates mechanical fastening systems common to other industries but uniquely fashioned in said invention. Said apparatus provides a device and method of attachment of living organisms to substrate while avoiding the laborious method of scarify or otherwise aggressively abrading a submerged attachment surface area and without the need for the underwater application of a chemical adhesive. Typical joinery appliances such as male threaded stud and female threaded sleeve, push lock, twist lock, snap lock and other joinery systems are suitable for incorporation into said apparatus.

Another characteristic and benefit of another embodiment of said receiver component is the creation of protective habitat for small and juvenile fish by the resulting gaps and spaces created between a canopy forming cantilever shape of the receiver component and the surface of the nearby substrate to which said canopy forming shaped receiver component is attached.

Another characteristic and benefit of another embodiment of said receiver component is the ability to populate said receiver component with a plurality of said mounting components while above the surface of the water. Said receiver component, with attached organisms is then deployed below the surface of the water and the entire apparatus assemblage is attached to a prepared submerged substrate.

Another characteristic and benefit of another embodiment of said receiver component is the ability to temporarily populate a tray shaped receiver component comprising a plurality of receiver features which are capable of joining a plurality of said mounting components, therefore providing stable support of said living organisms during culture of said organisms in a nursery environment and during transport of said organisms to a deployment location. Said stable support reduces said organism's stress from mishandling, prevents spillage of said organisms during transport and aids in the labeling and organizing of said organisms. Said apparatus uniquely provides improved and more efficient methods of supporting, handling and transporting cultured organisms during the process of cultivation, propagation, handling and final placement in a submerged environment. Said tray shaped receiver component can temporarily support a plurality of said organisms on said tray shaped receiver component while located in a nursery or lab. Said tray shaped receiver component can also support a plurality of said affixed organisms during transportation to other locations. Said nursery or lab may be a support tank located in a facility on land or on a vessel. Said nursery or lab may also be a rack-like storage device uniquely formed to receive and support a plurality of said tray shaped receiver components. A plurality of said tray shaped receiver components may also be temporarily installed in a water filled portable tank which is capable of supporting the life, and reducing the stress, of said living sessile organisms during transport form one location to another.

Another characteristic and benefit of an appendage version of said receiver component is the ability of said component to support a plurality of said mounting components on a linear shaped receiver component appendage in which said linear shaped receiver component is made part of a tree like assembly of similar said linear shaped receiver components. Said tree like assembly is suspended in a water column between, and held in position by, an anchoring device and a flotation device. Said assembly provides an apparatus and method of growing cultured living sessile organisms in an open water environment. Recent research has determined that organisms cultured while dangling from a line can develop elongated and therefore weaker skeletal structures compared to organisms which are securely stabilized. Said assembly of linear shaped receiver components provides that stability while exposing each said organism to sustainable amounts of light and nutrient exposure.

Said invention provides for the rapid, efficient, sustainable and environmentally responsive cultivation and attachment of living sessile organisms to fabricated or natural submerged substrate. Those persons skilled in the art and familiar with current industry practices of propagating, cultivating and out planting living sessile organisms will quickly see the benefits of the methods and apparatus that constitute this instant invention and other applications of this instant invention will become obvious to said persons besides those embodiments described below.

The examples illustrated and described herein as well as examples not specifically described herein but within the scope of aspects of the disclosure constitute exemplary means for reducing trauma and stress to living sessile organisms during culture; exemplary means for reducing trauma and stress to living sessile organisms during deployment and attachment to submerged reef substrate; exemplary means for providing a much improved means of attaching living sessile organisms to submerged substrate; exemplary means for creating habitat for fish to actively promote reef life.

The term “exemplary” is intended to mean “an example of.” The articles “said,” “the,” “a,” and “an,” are intended to mean that there are one or more of the elements when introducing elements of aspects of the disclosure or the examples thereof. The terms “having,” “including,” and “comprising” are intended to be inclusive and mean that there may be additional elements other than the listed elements.

It will be apparent that modifications and variations are possible without departing from the scope of aspects of the disclosure as defined in the claims. As various changes could be made in the above constructions, products, and methods without departing from the scope of aspects of the disclosure, it is intended that all matter contained in the above description and shown in the accompanying drawings shall be interpreted as illustrative and not in a limiting sense.

### BRIEF DESCRIPTION OF THE DRAWINGS

FIG. 1 illustrates an embodiment of the present invention showing an apparatus composed of a mounting component with attached living sessile organism and receiver component.

FIG. 2 illustrates an embodiment of the present invention showing an apparatus composed of a mounting component with attached living sessile organism and receiver component.

FIG. 3 illustrates an embodiment of the present invention showing an apparatus composed of a mounting component with attached living sessile organism and receiver component.

FIG. 4 illustrates an embodiment of the present invention showing an apparatus composed of a mounting component with attached living sessile organism and a receiver component.

FIG. 5 illustrates an embodiment of the present invention showing an apparatus composed of a mounting component with attached living sessile organism and a receiver component.

FIG. 6 illustrates an embodiment of the present invention showing an apparatus composed of a mounting component and a receiver component.

FIG. 7 illustrates an embodiment of the present invention showing a plurality of apparatus within a container shaped vessel.

FIG. 8 illustrates an embodiment of the present invention showing a submerged assembly.

FIG. 9 illustrates an embodiment of the present invention showing an assembly of a plurality of undulating, canopy forming cantilever shaped receiver components.

FIG. 9A illustrates a partially cut away view of said receiver component 56 which is the preferred embodiment as illustrated and described in FIG. 9.

### DESCRIPTION OF THE PREFERRED EMBODIMENTS

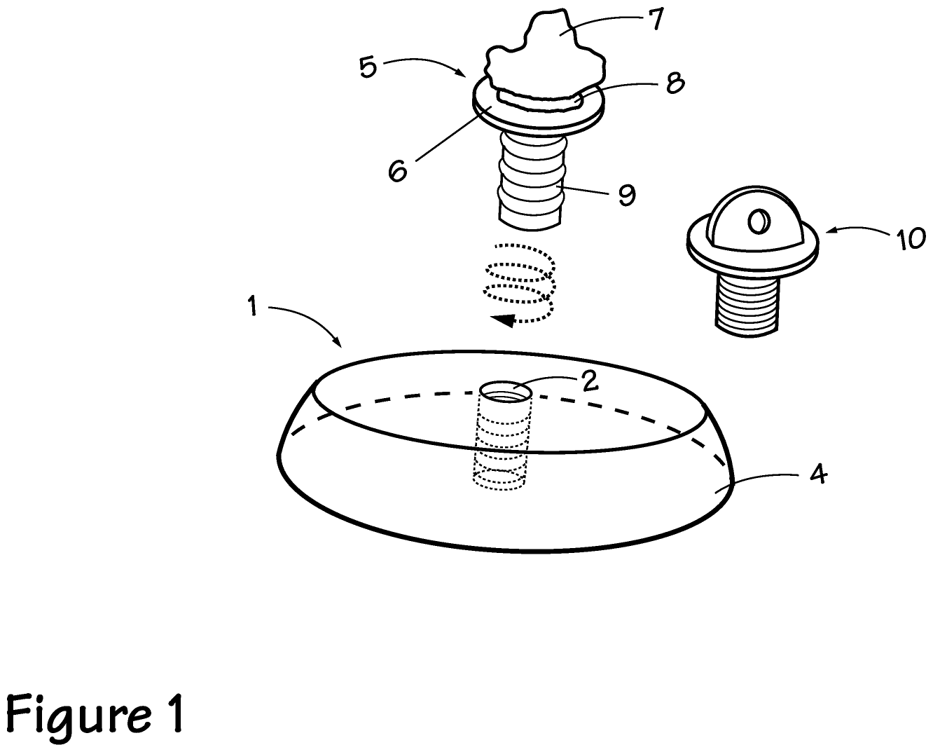

FIG. 1 illustrates a preferred embodiment of the present invention. In this embodiment the apparatus is composed of a mounting component with attached living sessile organism 5 and a receiver component 1. Said mounting component has an obverse exterior surface area 6 capable of supporting living sessile organisms 7 which is affixed to said obverse surface 6 with an adhesive substance such as polyepoxide or cyanoacrylate 8. Said receiver component 1 of the two-part mechanical attachment apparatus has an annular sleeve 2 with female threads 3 with at least one open end located on the surface of the base form 4 of said receiver component 1. An appendage with male threads 9 projects downwardly from the reverse exterior side of said mounting component 5. Said male threads have a pitch and diameter compatible with the pitch and diameter of female threads 3 which facilitate the mechanical joining of said components. In this embodiment, a temporary plug 10 is inserted into said annular sleeve of said receiver component 1 in order to prevent fouling of said interior threads 3 by marine growth in the event said receiver component 1 is submerged for a sufficient period of time for said growth to occur prior to insertion of said mounting component 5. Said plug 10 is removed prior to joining said mounting component 5 to said receiver component 4 of said attachment apparatus. Said receiver component 5 is fixed to, inserted into, or intrinsically incorporated as a part of, substrate which is submerged or intended to be submerged in a marine environment prior to the union of said mounting component 5 together with said receiver component. The method for joining said mounting component 5 with said receiver component 4 is a two-step process. The first step is to remove said temporary protective plug 10, if required, from said receiver component 1. The second step is to align said threaded appendage 9 of said mounting component 5 with said annular opening of receiver component 1. Said mounting component 5 and said receiver component 1 are then joined by screwing said mounting component 5 into said receiver component 1 to firmness.

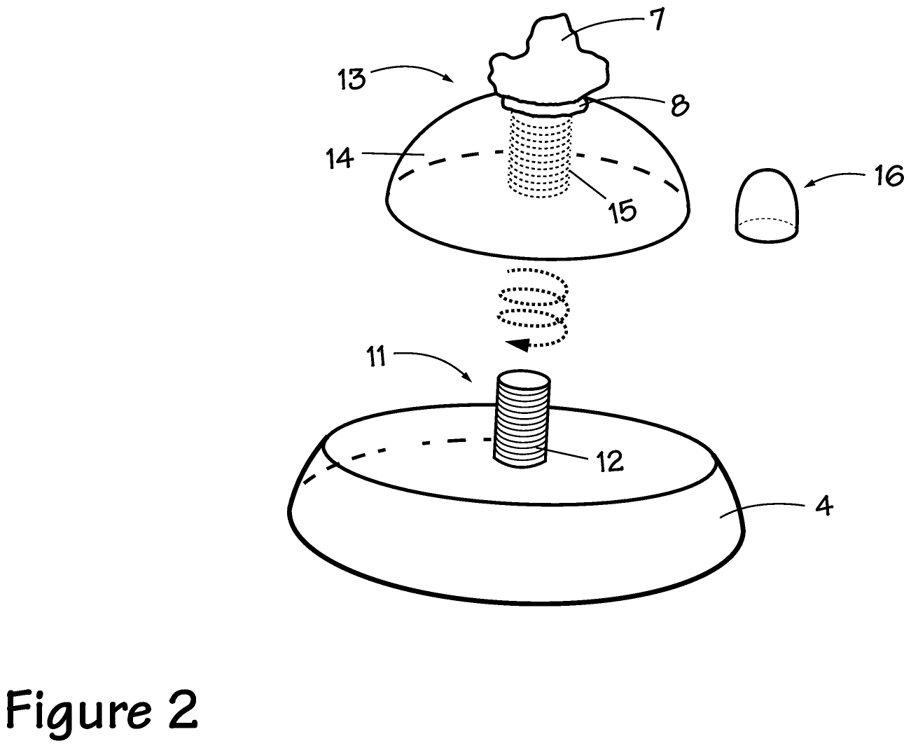

FIG. 2 illustrates a preferred embodiment of the present invention. In this embodiment the apparatus is composed of a mounting component with attached living sessile organism 13 and a receiver component 11. Said receiver component 11 is composed of a cylindrical stud with exterior male threads 12 which projects upwardly from the exterior surface of a base form 4. Said mounting component 13 has an obverse exterior surface area 14 which is capable of supporting the adherence of the living organisms 7 which is affixed to said obverse surface area 14 with an adhesive substance such as polyepoxide or cyanoacrylate 8. An annular sleeve 15 with interior female threads, having a thread pitch and interior diameter compatible with the thread pitch and diameter of said exterior male threads 12 is located within the interior of said mounting component 13. The bottom of said annular sleeve 15 is open to the exterior of said mounting component 13. In this embodiment, the exterior male threads of said receiving component 11 may be temporarily covered by a cap 16 to prevent fouling by marine growth. The method for joining said mounting component 13 to said receiver component 11 is a two-step process. The first step is to remove said temporary protective cap 16, if required, from said receiver component 11. The second step is to align bottom opening of said annular sleeve 15 with the receiver component 11. Said mounting component 13 and said receiver component 11 are then joined by screwing said mounting component 13 onto said receiver component 11 to firmness.

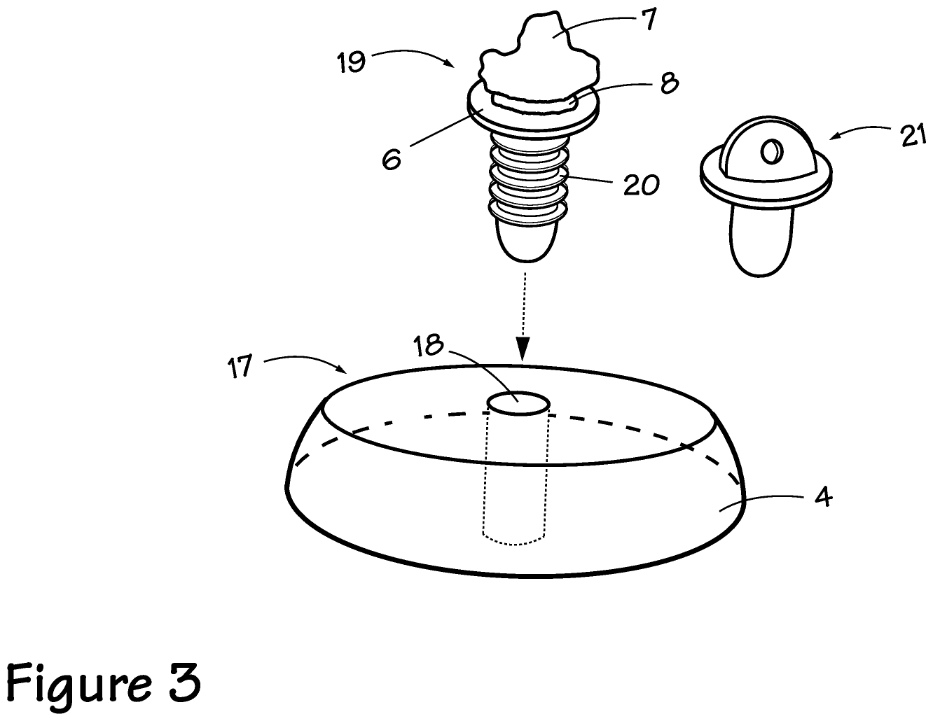

FIG. 3 illustrates a preferred embodiment of the present invention. In this embodiment the apparatus is composed of a mounting component with attached living sessile organism 19 and a receiver component 17. Said mounting component 19 has an obverse exterior surface area 6 capable of supporting living sessile organisms 7 which is affixed to said obverse surface 6 with an adhesive substance such as polyepoxide or cyanoacrylate 8. Said mounting component 19 has a downwardly projecting barbed appendage 20 located on the reverse side of said obverse surface area 6. A single or plurality of semi-flexible discs, fins or barbs project outward from the central axis of said appendage 20. Said receiver component 17 is fixed to, formed or drilled into substrate 4 and has an annular or rectilinear hole 18 which is in an orientation in which the vertical axis of said receiver component 17 is approximately perpendicular to the average surrounding surface plane of said substrate 4. The open end of said hole 18 is flush with the surface of said substrate 4 and exposed to the exterior area surrounding said substrate 4.

The length of said hole 18 is deeper than said barbed appendage 20 is long. The interior cross-sectional diameter of said hole 18 is sufficiently smaller than the exterior cross-sectional diameter of said barbed appendage 20 in order to provide for a firm fit capable of resisting dislodgement. In this embodiment, said annular hole 18 may be temporarily occupied by a plug 21 to prevent fouling of the interior area of said receiver component 17 by marine growth.

The method for joining said mounting component 19 to said receiver component 17 is a two-step process. The first step is to remove said temporary protective plug 21, if required, from said receiver component 17. The second step is to align said barbed appendage 20 with the interior of said hole 18. Said component 17 and said component 19 are then joined by pushing said mounting component's appendage 20 into said hole 18 to firmness.

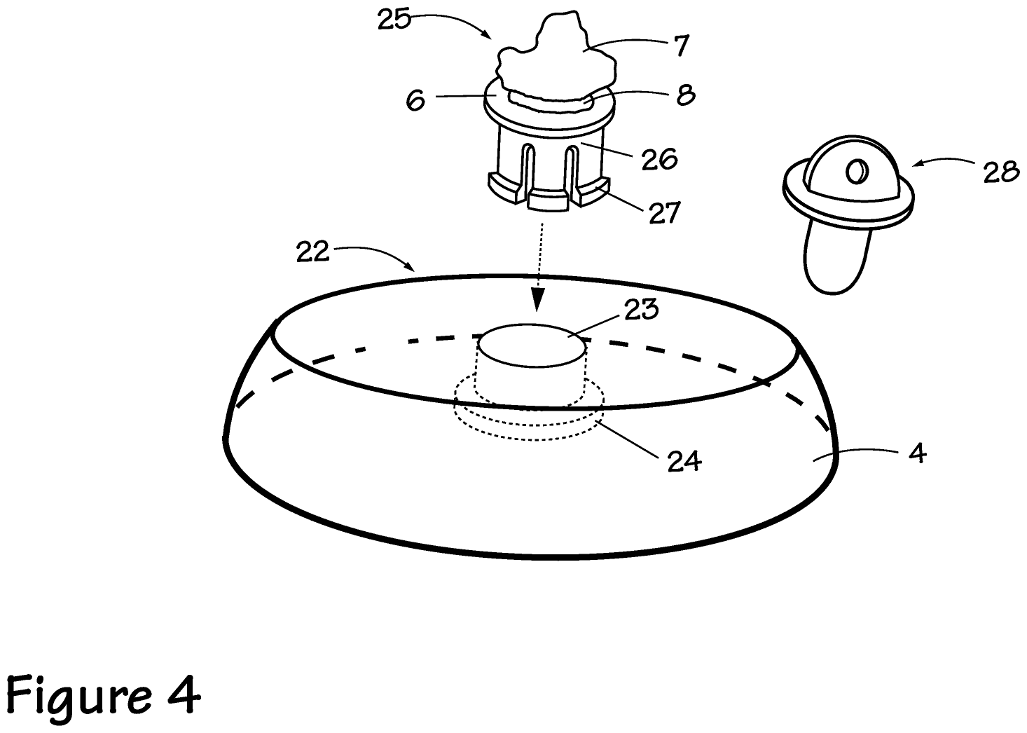

FIG. 4 illustrates a preferred embodiment of the present invention. In this embodiment the apparatus is composed of a mounting component with attached living sessile organism 25 and a receiver component 22. Said mounting component has an obverse exterior surface area 6 capable of supporting living sessile organisms 7 which is affixed to said obverse surface 6 with an adhesive substance such as polyepoxide or cyanoacrylate 8. Said receiver component has an annular sleeve 23 with an open end located on the surface of a base form 4 and an enlarged interior undercut 24. An appendage 26 projects downwardly from the reverse exterior side of said mounting component 25. Said appendage 26 is sufficiently flexible to provide for the temporary deformation of projecting barbs 27 to compress and then express into said enlarged interior undercut 24. The interior of said hole 23 may be temporarily occupied by a plug 28 to prevent fouling by marine growth.

The method for joining said mounting component 25 to said receiver component 22 is a two-step process. The first step is to remove said temporary protective plug 31, if required, from said receiver component 22. The second step is to align said appendage 26 with the interior of said hole 23. Said component 25 and said component 22 are then joined by pushing said appendage 26 into said hole 23 causing the temporary deflection of said barbs 27 until the correct penetration depth is achieved at which point each said barbs 27 release their tension and lock into place within said undercut 24.

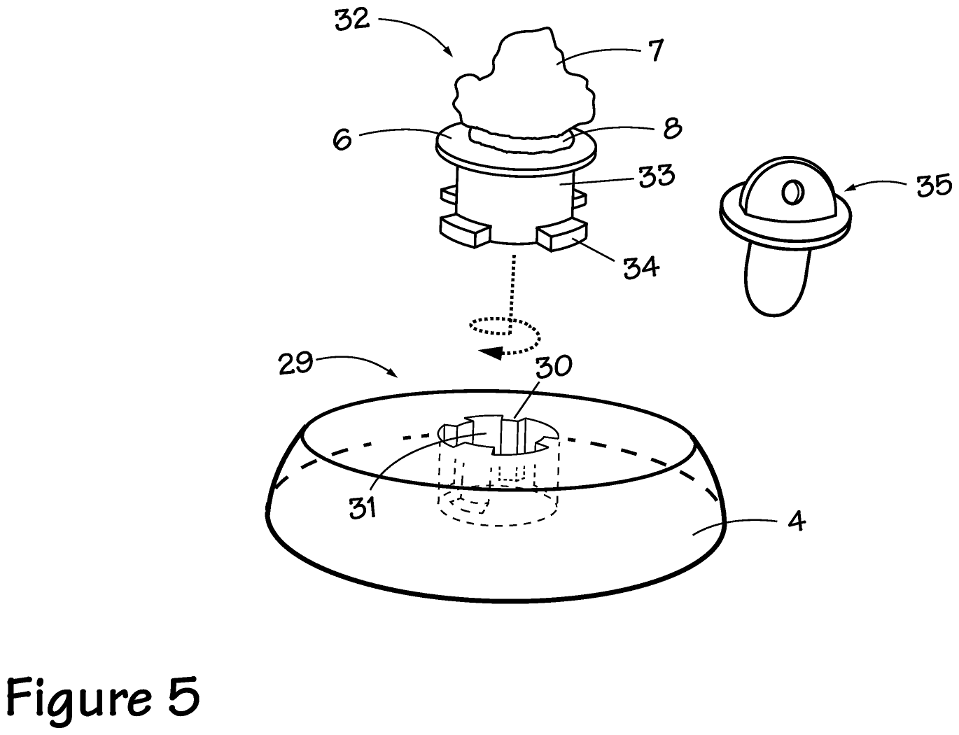

FIG. 5 illustrates a preferred embodiment of the present invention. In this embodiment the apparatus is composed of a mounting component with attached living sessile organism 32 and a receiver component 29. Said mounting component has an obverse exterior surface area 6 capable of supporting living sessile organisms 7 which is affixed to said obverse surface 6 with an adhesive substance such as polyepoxide or cyanoacrylate 8. Said receiver component has an annular sleeve 30 with an open end located on the surface of a base form 4. The surface wall of said sleeve has a plurality of vertical channels which terminate with an enlarged undercut 31. An appendage 33 projects downwardly from the reverse exterior side of said mounting component 32. Said appendage 33 has intermittent projecting barbs 34 positioned at the base. Said barbs 34 conform in size and shape to said undercuts located in said sleeve 30. The interior of said sleeve 30 may be temporarily occupied by a plug 35 to prevent fouling by marine growth.

The method for joining said mounting component 32 to said receiver component 29 is a two-step process. The first step is to remove said temporary protective plug 35, if required, from said receiver component 29. The second step is to align said appendage 33 with the interior of said sleeve 30. Said component 32 and said component 29 are then joined by fully pushing said appendage 33 into said sleeve 30 and then twisting said mounting component 32 causing said barbs 34 to lock into said undercuts located in said sleeve 30.

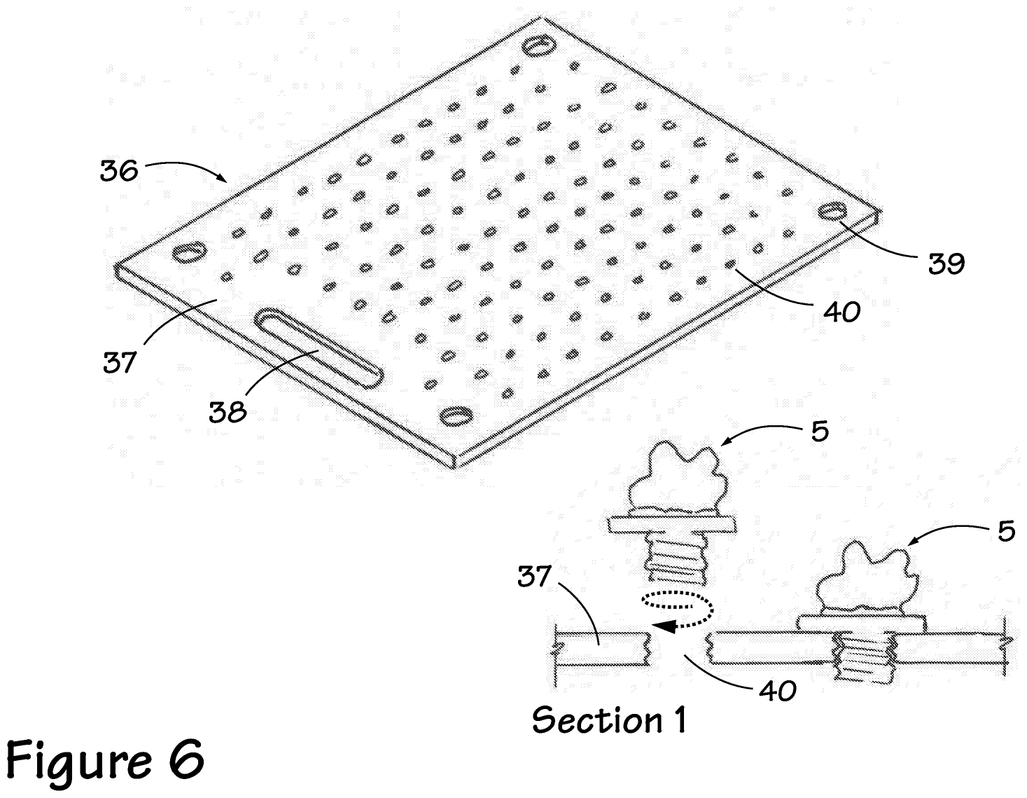

FIG. 6 illustrates a preferred embodiment of the present invention. In this embodiment the apparatus is composed of a mounting component 5 and a receiver component 36. Said mounting component 5 is as described in FIG. 1. Said receiver component 36 is a rectangular tray shaped form 37 composed of rigid material with a single opening 38 which serves as a handle. Said receiver component 36 has a plurality of openings 40. Each said opening 40 is perpendicular to the plane surface of said rectangular form 37. Each said opening 40 has an interior wall with female threads capable of mating with the male threaded portion of said mounting component 5. Said receiver component 36 has a plurality of perforations 39 which are oriented and positioned to facilitate temporarily securing receiver component 36 to another form. The method for joining said mounting component(s) 5 with said receiver component 36 is to align the male threaded portion of said mounting component 5 with each said threaded opening 40. Said mounting component 35 and said receiver component 36 are then joined by screwing said mounting component 5 into said opening 40 to partial firmness.

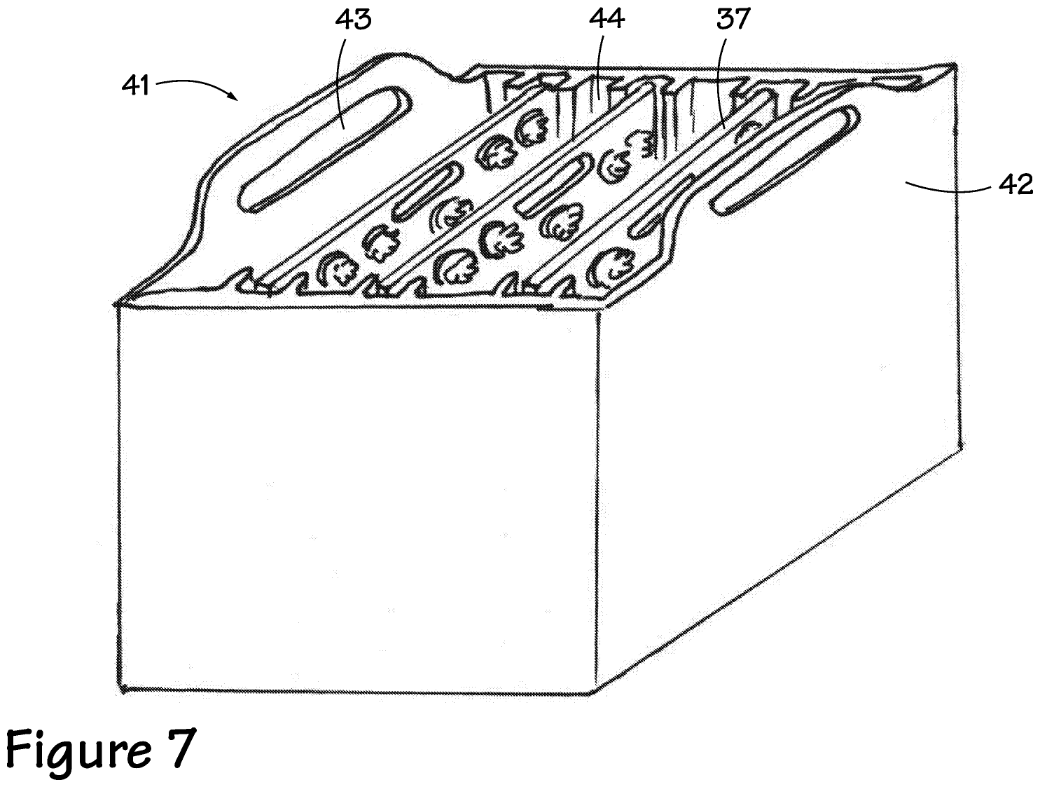

FIG. 7 illustrates a preferred embodiment of the present invention. In this embodiment a plurality of apparatus 37, as described in FIG. 6 are illustrated within a container shaped vessel 41. Said vessel 41 is composed of a solid bottom, four side walls and an open top. Said vessel 41 has a plurality of formed channels 44 which are perpendicular to the bottom plane of said vessel 41 and located on two opposing interior sides. Said channels 44 are organized and sized to accommodate insertion of each apparatus 37. Said vessel 41 contains a single opening 43 located on each of two opposing walls which serve as handles. Said vessel 41 is sufficiently deep to allow for said apparatus, when fully inserted, to be completely submerged in water.

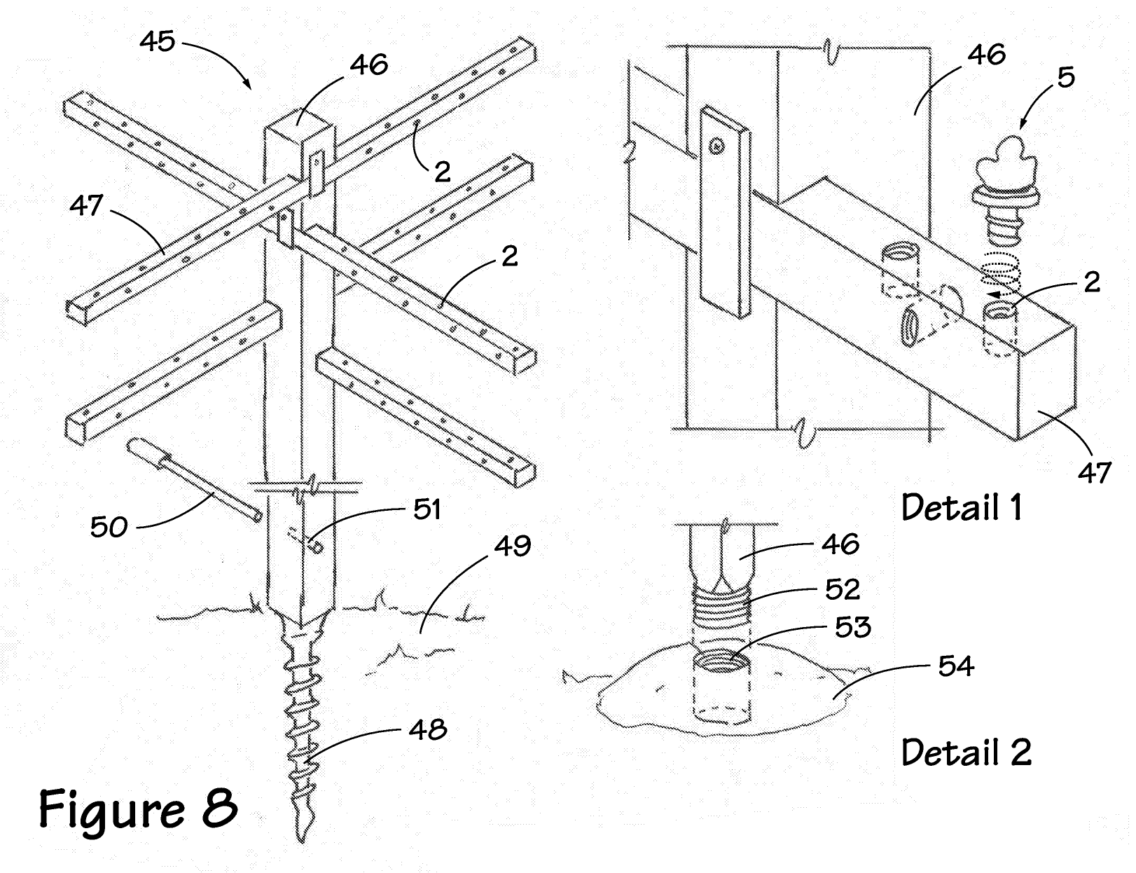

FIG. 8 illustrates a preferred embodiment of the present invention. In this embodiment a submerged assembly 45 is illustrated. Said assembly is composed of a central post 46 to which linear receiver components 47 are attached. Each said receiver component contains a plurality of female threaded annular sleeves 2 capable of coupling with said mounting component with attached living sessile organism 5 as described in FIG. 1 and further illustrated in Detail 1. In this embodiment said post 46 terminates in a screw shaped form 48 which is twisted into a soft substrate 49 by means of a removable turning rod 50 which is temporarily inserted into a hole 51 located in said post 46. Alternatively, said post 46 is anchored into a ballast form 54 which contains a female threaded hole 53, Said hole 53 is capable of being mechanically joined to the male threaded terminus 52 of alternate post 46 as illustrated in Detail 2.

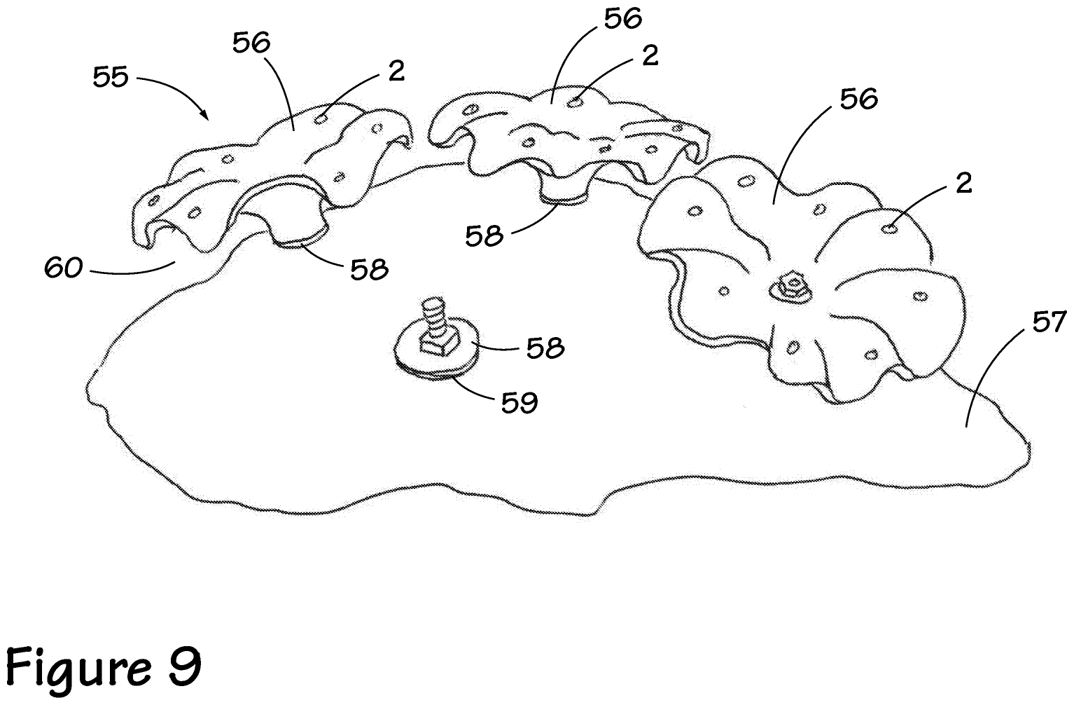

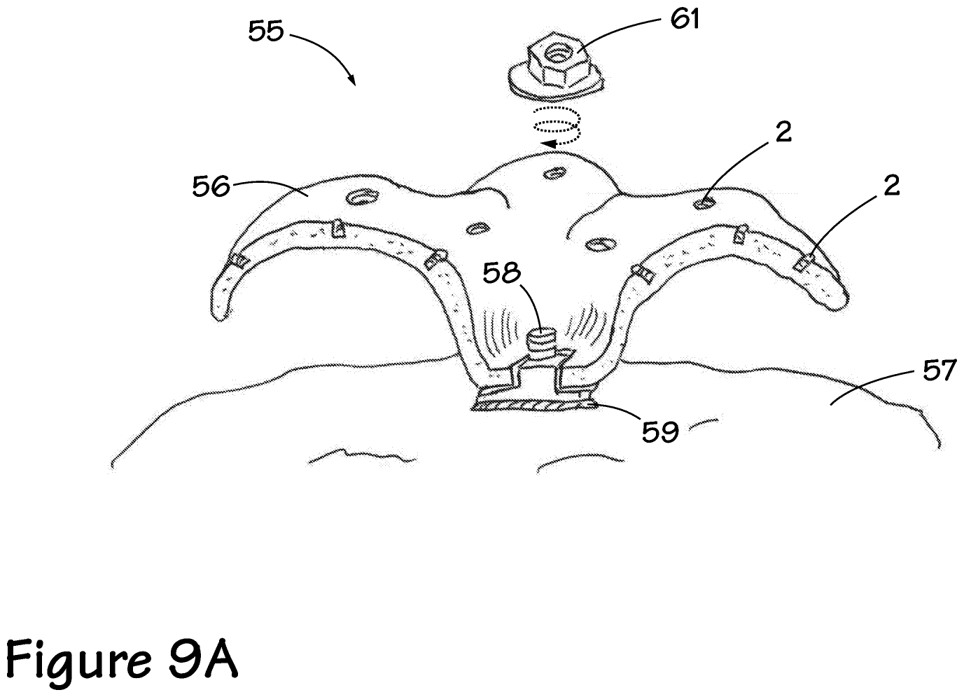

FIG. 9 illustrates a preferred embodiment of the present invention. In this embodiment an assembly 55 of a plurality of undulating, canopy forming cantilever shaped receiver components 56 is illustrated. Each said receiver component 56 contains a plurality of annular sleeves 2 as illustrated and described in FIG. 1 which are capable of being joined by said mounting component with attached living sessile organism 5 as also illustrated and described in FIG. 1. Said receiver components 56 are attached to and held in place by, a male threaded apparatus 58 which is permanently fixed with an adhesive substance 59 to a substrate 57 that is submerged or intended to be submerged in a marine environment. The attachment of receiver component 56 to substrate 57 creates a partially open interstitial habitat space 60 which is located between the undersurface of receiving component 56 and the upper surface of substrate 57. Said habitat space 60 is of varying size and complexity.

FIG. 9A illustrates a partially cut away view of said receiver component 56 which is one of a plurality of similar receiver components comprising the assembly 55 of the preferred embodiment as illustrated and described in FIG. 9. In this illustration said receiver component 56 is partially illustrated with a cut away view to better illustrate the preferred form of attachment by said male threaded apparatus 58. Said receiver components 56 are attached to and held in place by, said male threaded apparatus 58 which is permanently fixed to said substrate 57 with an adhesive substance 59. A nut shape form 61 is threaded onto said apparatus 58 which firmly secures receiver component 56 in position.

What is claimed is:

1. A two-component apparatus for mechanically attaching live sessile marine organisms to an underwater object comprising:
an upper component and a lower component;
said upper component is portable;
said upper component comprising a living sessile organism which said organism is permanently attached to said upper component by means of chemical adhesive;
said upper component comprising physical features compatible with corresponding features of said lower component suitable for the mechanical joining of said upper component to said lower component;
said lower component comprising physical features compatible with corresponding features of said upper component suitable for the mechanical joining of said lower component to said upper component;
said lower component is permanently fixed to an object submerged in a marine environment;

2. The apparatus of claim 1 wherein:
said lower component is permanently affixed to an object which is intended to be submerged in a marine environment;

3. The apparatus of claim 1 wherein:
said lower component is incorporated into the form of an object which is intended to be submerged in a marine environment;

4. The apparatus of claim 1 wherein:
said lower component comprising a plurality of said compatible features;
said features comprising mechanical joinery to a plurality of said upper components.
said lower component comprising of a form, a portion of which cantilevers outward from said component's anchoring point thereby creating spaces suitable for habitat.

4. The apparatus of claim 1 wherein:
a portion of said mounting component comprising a male threaded appendage suitable for mechanically mating with, and joining to, the receiver threaded sleeve which is suitable for mechanically mating with, and joining to, the receiver component of said attachment apparatus which has a similarly sized female threaded appendage suitable for such purpose

5. The apparatus of claim 1 wherein:
a portion of said mounting component comprising a female threaded appendage suitable for mechanically mating with, and joining to, the receiver threaded sleeve capable of mechanically mating with, and joining to, the receiver component of the attachment apparatus comprising a similarly sized male threaded appendage for such purpose.

6. The apparatus of claim 1 wherein:
a portion of said mounting component comprising a barbed appendage suitable for mechanically mating with and fixing to the receiver component of the apparatus comprising a sized female sleeve suitable for gripping said appendage when appendage is inserted into said sleeve.

7. The apparatus of claim 1 wherein:
a portion of said mounting component comprising a male snap lock appendage suitable for mechanically mating with and fixing to the receiver component of the apparatus comprising a sized female sleeve suitable for gripping said appendage when appendage is inserted into said sleeve.

8. The apparatus of claim 1 wherein:
a portion of said mounting component comprising a male twist lock appendage suitable for mechanically mating with and fixing to said receiver component of the apparatus comprising a sized female sleeve suitable for gripping said appendage when appendage is inserted into said sleeve.

9. The apparatus of claim 1 wherein:
a portion of said mounting component comprising a female threaded appendage suitable for mechanically mating with, and joining to, the receiver threaded sleeve capable of mechanically mating with, and joining to, the receiver component of the attachment apparatus comprising a similarly sized male threaded appendage for such purpose.

10. The apparatus of claim 1 wherein:
a portion of said components comprising a partial coating of a polymer adhesive prior to joining.

11. A two-component apparatus for temporarily mechanically attaching live sessile marine organisms to a transportable object comprising:
an upper component and a lower component;
said upper component is portable;
said upper component comprising a living sessile organism which said organism is permanently attached to said upper component by means of chemical adhesive;
said upper component comprising physical features compatible with corresponding features of said lower component suitable for the mechanical joining of said upper component to said lower component;
a lower component comprising:
a tray shape form;
a plurality of receiver holes recessed into the upper surface of said form;
said receiver holes comprising physical features compatible with corresponding features of said upper component suitable for the mechanical joining of said lower component to said upper component;

12. A two-component apparatus for temporarily mechanically attaching live sessile marine organisms to an assemblage suitable for submerged propagation of said organisms comprising:
an upper component and a lower component;
said upper component is portable;
said upper component comprising a living sessile organism which said organism is permanently attached to said upper component by means of chemical adhesive;
said upper component comprising physical features compatible with corresponding features of said lower component suitable for the mechanical joining of said upper component to said lower component;
A lower component comprising:
A linear shape form;
a plurality of receiver holes recessed into the outer surfaces of said form;
said receiver holes comprising physical features compatible with corresponding features of said upper component suitable for the mechanical joining of said lower component to said upper component;
